(19) United States
(12) Patent Application Publication
(10) Pub. No.: US 2007/0138359 A1
(43) Pub. Date: Jun. 21, 2007

(54) PORTABLE LIMB

(76) Inventor: Norman Eugene Johnson, Madison, MS (US)

Correspondence Address: NEIL J. COIG, 2355 DRUSILLA LANE, BATON ROUGE, LA, 70809, US

(21) Appl. No.: 11/306,271

(22) Filed: Dec. 21, 2005

(51) Int. Cl. A47B 96/06; A47G 29/00; A47K 1/00; E04G 3/00; E04G 5/06; F21V 21/00; F21V 35/00

(52) U.S. Cl. 248/218.4

(57) ABSTRACT

A compact and easily transportable apparatus for hoisting objects capable of using only a tree as support.

### BACKGROUND OF THE INVENTION

The present invention relates to an apparatus capable of providing a portable support for suspending various items, such as game, supplies and the like. This type of suspension is typically done by way of suspension from a ceiling, pole, rigging, or any other way of suspend a desired object from a support above. When away from the conveniences of edifices, (such as in the wilderness) however, it may prove to be difficult to find a location to suspend items from, and even harder to find something at a usable and at an easily accessible height.

In the traditional mode of suspending objects, a mast or some type of edifice that extends from the ground must be utilized in order to hoist an object up. Placing a rope across a ceiling joist, for example, enables one to lift up objects from the ground by attaching the object to one end of the rope, and pulling up on the other across the joist. With the aid of pulleys at strategic locations and utilizing leverage, large objects can thus be raised. This technique is especially helpful when skinning game, as the animal harvested must be suspended in order to quickly and easily prepare the animal for processing and/or storage.

Obvious downsides to the current method of suspending objects are apparent. The above conditions are adequate when there exists an edifice or other structure for suspending the desired object. However, often there are not adequate places to suspend such an object from, or there are no usable locations. When hunters, for example, are in a forested area, there may be a great many trees, but they may not be of a usable height, or they may not have branches that are low enough or strong enough to be of use. When that situation arises, alternate methods of hoisting must be implemented, which can involve cumbersome apparatus, or other methods of lifting objects that are complicated or bothersome, such as trying to throw ropes across high branches or other techniques.

The consequence of these issues is either spending lots of time trying to suspend the object, having complicated or expensive equipment needed to achieve the desired hoist or simply not being able to hoist the desired object at all. Also, permanent rigging may not be desired in a location that could otherwise be utilized for storage space, even when not in the rural setting described above. As such, an improved apparatus is needed to provide a hoisting point for the above situations.

The present invention is thus a much-improved mode of handling this challenge, by making any tree of adequate diameter into a possible hoisting point with a small, lightweight and inexpensive item.

Other inventors have attempted to address the presented problem, such as the inventions disclosed in U.S. Pat. No. 6,695,688 to Owen. However, this reference is a complicated and large variant of a portable hoist, and is neither as efficient nor as easy to use as the present invention. Clearly then, the present invention offers a much more complete and efficient solution that has yet to be recognized.

All of these aspects of the current mode of hoisting in a forested area lead to an increased need for a revised device for hoisting, all of which the present invention addresses.

### OBJECTS OF THE INVENTION

One object of the invention is to provide an apparatus for hoisting objects while in a forested area.

Another object of this invention is to provide an apparatus for hoisting that is lightweight.

Yet another object of this invention is to provide an apparatus for hoisting that is easy to use.

Still another object of this invention is to provide an apparatus for hoisting that has a small footprint.

Still another object of this invention is to provide an apparatus for hoisting that is portable.

Other objects and advantages of this invention shall become apparent from the ensuing descriptions of the invention.

### SUMMARY OF THE INVENTION

According to the present invention, a compact and easily transportable apparatus for hoisting objects capable of using only a tree as support is disclosed.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a left side view of the portable limb.

FIG. 2 is a right side view of the portable limb.

FIG. 3 is a top view of the portable limb in the folded, or storage, position.

FIG. 4 is a perspective view of the portable limb as attached to a tree.

### DETAILED DESCRIPTION OF EXEMPLARY EMBODIMENTS

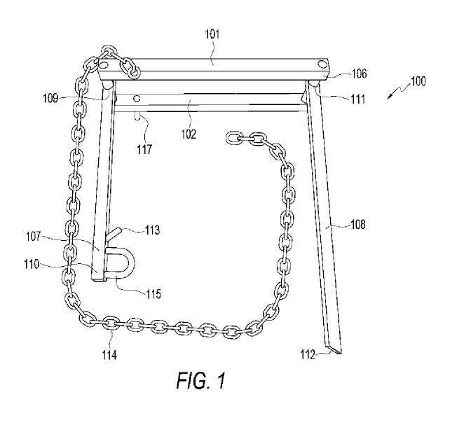

Without any intent to limit the scope of this invention, reference is made to the figures in describing the various embodiments of the invention. FIGS. 1-4 show various aspects of exemplary embodiments of the present invention.

The present invention of portable limb 100 is constructed of first side member 101 and second side member 102. Each of these side members had a first opposite end 103 and 104 and a second opposite end 105 and 106. Between these side members is a rotatably attached boom member 107 and support member 108. Boom member 107 has attachment end 109 and suspending end 110. Similarly, support member 108 has attachment end 111 and interlocking end 112. Both boom member 107 and support member 108 are angled or otherwise configured on their attachment ends 109 and 111 to aid in attaching to the tree, either with angled faces which can anchor in a tree, or other method of creating friction which secures portable limb 100.

An interlocking relationship is established between interlocking mechanism 113 which is located near suspending end 110 of boom member 107 and interlocking end 112 of support member 108. An example of such a mechanism is a pin 113 and a hollowed-out or receptacle portion of interlocking end 112, in a male-female locking arrangement.

Finally, securing tether 114, such as a chain, rope or similar mechanism, is used to attach portable limb 100 to a tree or other object. Securing tether 114 is attached to first side member 101 and second side member 102. Attachment may be achieved in various configurations; however, pictured, the chain is affixed to first side member 101, and can be locked to second side member 102 via an attachment cleat 117, such as hook or similar device. There may also be and eye or similar suspending connection 115 that can be used to loop through rope, a pulley or similar device which is located near suspending end 110 of boom member 107. A gambrel can also be employed for holding game, such as deer, in order to better position the game while suspended.

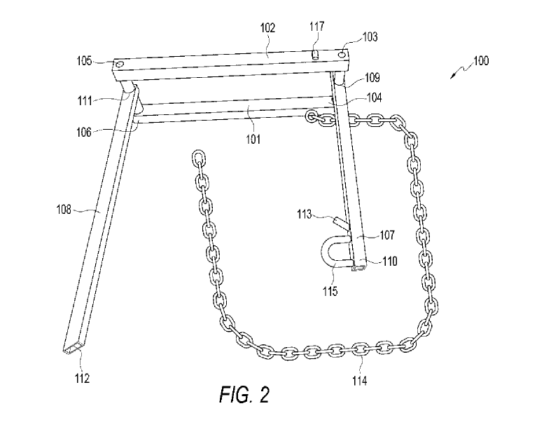

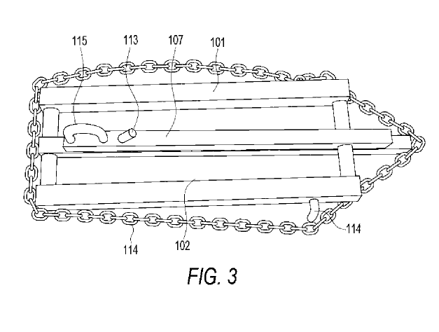

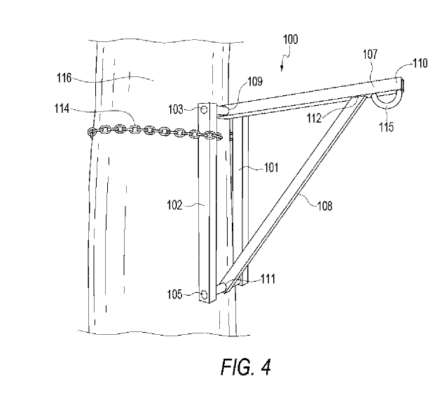

In operation, portable limb 100 is unfolded as in FIGS. 1 and 2, from the storage position shown in FIG. 3. Side members 101 and 102 are placed against the object being used for support, such as tree 116, as shown in FIG. 4. Support member 112 is rotated to an angle approximately 45 degrees to side members 101 and 102, whereby interlocking end 112 engages interlocking mechanism 113 located on boom member 107, which is approximately perpendicular to tree 116, or approximately parallel to the ground beneath. Tether 114 is then wrapped around tree 116 and secured to first side member 101 and second side member 102 to secure it to tree 116.

Removal is the reverse of installation.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A portable limb comprising:
a. a first side member having first and second opposite ends;
b. a second side member having first and second opposite ends;
c. a boom member having an attachment end and a suspending end and rotatably attached at said attachment end between said first opposite ends of said first side member and said second side member;
d. a support member having an attachment end and a interlocking end and rotatably attached at said attachment end between said second opposite ends of said first side member and said second side member;
e. an interlocking mechanism operatively configured near said suspending end of said boom member and configured to attach to said interlocking end of said support member; and
f. a securing tether having at least one detachable connection to said first side member and said second side member, configured to attach to a stationary object.

2. The portable limb of claim 1 further comprising an eye operatively configured near said suspending end of said boom member.

3. The portable limb of claim 1 wherein at least one of said attachment ends is configured to anchor to said stationary object.

4. The portable limb of claim 1 wherein said securing tether is a chain.

5. A portable limb comprising:
a. a first side member having first and second opposite ends;
b. a second side member having first and second opposite ends; p1 c. a boom member having an attachment end and a suspending end and rotatably attached at said attachment end between said first opposite ends of said first side member and said second side member;
d. a support member having an attachment end and a interlocking end and rotatably attached at said attachment end between said second opposite ends of said first side member and said second side member;
e. an interlocking pin operatively configured near said suspending end of said boom member and configured to attach to said interlocking receptacle of said support member;
f. a securing tether having a detachable connection to said first side member and a cleat operatively configured on said second side member, wherein said securing tether is configured to attach to a stationary object; and
g. wherein at least one of said attachment ends is configured to anchor to said stationary object.
